(19) United States
(12) Patent Application Publication
(10) Pub. No.: US 2005/0265391 A1
(43) Pub. Date: Dec. 1, 2005

(54) Apparatus, system, and method for concurrent high-performance transport of variable-length messages

(76) Inventors: Robert Francis Bartfai, Tucson, AZ (US); Pierre-Fortin Jean-Denis, Tucson, AZ (US); Edward Hsin Wei Lin, Tucson, AZ (US); James Alan Springer, Tucson, AZ (US); Sherry Suzanne Worcester, Tucson, AZ (US)

Correspondence Address: KUNZLER & ASSOCIATES, 8 EAST BROADWAY, SUITE 600, SALT LAKE CITY, UT, 84111, US

(21) Appl. No.: 10/855,933

(22) Filed: May 27, 2004

(51) Int. Cl. H04J 3/24

(52) U.S. Cl. 370/474

(57) ABSTRACT

An apparatus, system and method of concurrent high-performance transport of variable-length messages are provided. The invention overcomes the problem of transporting a message comprising more bits than the maximum allowable group transmission on a network, by fragmenting the message into a plurality of data packets and transmitting the data packets concurrently. In addition, the present invention overcomes the problem of inefficient storage space allocation for reconstruction of the message from the data packets by sending the size of the message with each data packet.

### BACKGROUND OF THE INVENTION

1. Field of the Invention

This invention relates to transporting data and more particularly relates to transmitting data packets containing variable-length data strings to a remote device, and reconstructing the data string from received data packets.

2. Description of the Related Art

In the field of data transport, including peer to peer networks, server-client networks, wide area networks (WANs), telephone communication networks, laser communication networks, wireless communication networks, and the more broad networks of the internet (world wide web) which may include some or all of these components, there is a limit to the number of bits that can be transported in one group. Strings of data that need to be transported via such networks are often longer, in terms of bits, than the maximum transmission unit allowed by the network. One type of data transport protocol commonly used to resolve this issue involves fragmenting the data string into shorter, more manageable strings.

Current string fragmentation protocols can become problematic in several ways. To correctly reconstruct the string, the string fragments must be received in the same sequence in which they were sent. In many networks, specifically those that are inherently lossy, such as wireless networks, the string fragments may not only be received out of sequence, they may be lost completely. In such a case, the string cannot be reconstructed correctly and errors may occur, or alternatively, the string must be fragmented again and retransmitted using additional bandwidth. Additionally, the receiving device does not have any information regarding the size of the data string until the last packet is received. Therefore, it cannot accurately allocate space on a storage device sufficient to reconstruct the entire data string.

Consequently, a need exists for a process, apparatus, and system that efficiently transport variable-length data strings by allowing the receiving device to accurately allocate sufficient storage space to reconstruct the data string and correctly reconstruct the data string regardless of the sequence in which the data packets arrive.

### SUMMARY OF THE INVENTION

The present invention has been developed in response to the present state of the art, and in particular, in response to the problems and needs in the art that have not yet been fully solved by currently available data transport protocols. Accordingly, the present invention has been developed to provide a process, apparatus, and system for concurrent high-performance transport of variable-length messages that overcome many or all of the above-discussed shortcomings in the art.

The apparatus for concurrent high-performance transport of variable-length messages is provided with a logic unit containing a plurality of modules configured to functionally execute the necessary steps of fragmenting a data string into a plurality of data packets, transmitting the data packets, receiving of the data packets by a remote device and reconstructing the data string. These modules in the described embodiments include a string fragmentation module, a data transmitter module and a data receiver module.

The string fragmentation module of the apparatus, in one embodiment, is configured to fragment a data string and package the string fragments into data packets, each configured with the length of the data string. The data packets are preferably configured with additional control information including an identifier linking the data packet to the data string, the data packet sequence number, and an identifier indicating the last data packet in the sequence. The apparatus is further configured, in one embodiment, to calculate the number of data packets required to completely transmit the data string.

In a further embodiment, the apparatus includes a data transmitter module configured to transmit the data packets to a remote device via a connection employing a data transfer protocol. The data transmitter may also be configured to create threads to handle the concurrent transmission of multiple data packets from different clients.

In one embodiment, the apparatus is configured with a data receiver module which, upon receipt of one of the data packets, accurately allocates enough space on a storage device to completely reconstruct the data string. The data receiver module is preferably configured to insert the data packets sequentially into an array of arrays as they are received, and reconstruct the data string upon receipt of the final data packet. In an alternative embodiment, the data packets are inserted into an array of linked lists. The apparatus performs efficiently by eliminating the need to reallocate storage space, and move the data packets in the storage device, if insufficient space was allocated. This embodiment eliminates wasted space created during the space allocation process.

A system of the present invention is also presented for concurrent high-performance transport of variable-length messages. The system may be embodied as a network of devices configured with the data transport apparatus described herein. The system, in one embodiment, includes a transmitter device configured to fragment a data string into a plurality of data packets, each configured with the length of the data string. In one embodiment, the transmitting device packages control information including an identifier linking the data packet to the data string, the sequence number of the data packet, and an identifier indicating the last packet in the sequence with the data string fragment. In one further embodiment, the transmitting device is configured to calculate the number of packets required to completely transmit the data string. Additionally, the transmitting device may be configured to create threads to handle concurrent transmission of multiple data packets, and transmit the data packets via a connection employing a data transfer protocol to a remote device.

The system may further include a receiving device configured, in one embodiment, to receive data packets from a transmitting device, allocate space on a storage medium responsive to the length of the original data string included with the first received data packet, and reconstruct the data string from the data packets. In one embodiment, the receiving device accurately allocates enough storage space to reconstruct the data string upon receipt of one of the list fragments. In this embodiment, the data receiver inserts the incoming list fragments sequentially into an array, the sequence being determined by the sequence number sent with the data packet. The data string is reconstructed upon receipt of all of the data packets.

A process of the present invention is also presented for concurrent high-performance transport of variable-length messages. The process in the disclosed embodiments substantially includes the steps necessary to carry out the functions presented above with respect to the operation of the described apparatus and system. In one embodiment, the process includes fragmenting a data string into data packets, packaging the size of the data string with every data packet, transmitting the multiple data packets to a remote device, allocating space on a storage medium for string reconstruction and reconstructing the data string from the data packets on a remote device. The process also may include specifying a pointer to the location of the data string to be fragmented, and an identifier of the process on a remote device to receive the data string.

In a further embodiment, the process includes calculating the number of data packets required to completely transmit the data string. The string fragment is preferably packaged with control information including an identifier linking the data packet to the data string, the length of the original data string, the fragment sequence number, and an identifier indicating the last data packet in the sequence. In one embodiment, threads are created to handle concurrent transmission of multiple data packets. The data packets may be transmitted to a remote device via a connection employing a data transfer protocol.

In one embodiment of the process, the remote device allocates enough storage space to reconstruct the data string responsive the receipt of the first data packet. In a further embodiment, the data packets are inserted sequentially into an array until the final data packet is received. In this embodiment, the data string is reconstructed upon receipt of the final data packet. The process increases data transport reliability by sending the sequence number with every data packet, and reduces system resource waste by sending the size of the data string with every packet, thus eliminating any issues with allocation of storage space for reconstruction of the data string on the remote device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a system for concurrent high-performance transport of variable-length messages in accordance with the present invention;

FIG. 2 is a block diagram illustrating one embodiment of an apparatus for concurrent high-performance transport of variable-length messages in accordance with the present invention;

FIG. 3 is a block diagram illustrating one embodiment of a system for concurrent high-performance transport of variable-length messages in a peer to peer configuration in accordance with the present invention;

FIG. 4 is a block diagram illustrating one embodiment of a system for concurrent high-performance transport of variable-length messages in a server-client configuration in accordance with the present invention;

FIG. 5 is a block diagram illustrating one embodiment of a system for concurrent high-performance transport of variable-length messages in an asynchronous peer to peer remote copy configuration in accordance with the present invention;

FIG. 6 is a block diagram illustrating one detailed embodiment of the apparatus for concurrent high-performance transport of variable-length messages of FIG. 2 in accordance with the present invention;

FIG. 7 is a flow chart diagram illustrating one embodiment of a method for concurrent high-performance transport of variable-length messages in accordance with the present invention;

FIG. 8 is a flow chart diagram illustrating one detailed embodiment of the method for concurrent high-performance transport of variable-length messages of FIG. 7 in accordance with the present invention;

FIG. 9 is a conceptual illustration of one embodiment of the packaging structure of the control information with the string fragment in accordance with the present invention; and

FIG. 10 is a conceptual illustration representing one embodiment of an array of arrays in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

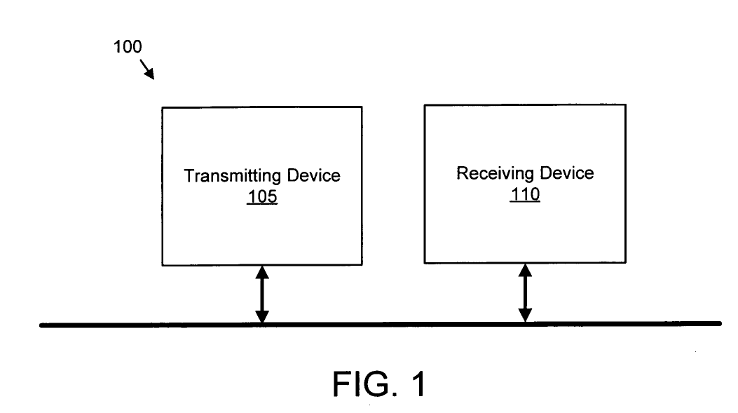

FIG. 1 depicts one embodiment of a system for transport of variable-length messages 100. The system 100 of the present invention includes a transmitting device 105 and a receiving device 110. In one embodiment of the system 100, a plurality of transmitting devices 105, or a plurality of receiving devices 110, or both may exist.

In one embodiment, the connection between the transmitting device 105 and the receiving device 110 is a wire connection. Any wire configuration may be used to connect the transmitting device 105 to the receiving device 110. Alternatively, the connection between the transmitting device 105 and the receiving device 110 may be a conducting strip embedded in an insulating or semi-conducting substrate. In an additional alternative embodiment, the connection between the transmitting device 105 and the receiving device 110 is wireless, the physical connection being radio or light waves. The connection between the transmitting device 105 and the receiving device 110 may also be fiber optic. Although these specific embodiments of the connection have been communicated, they are not intended to limit the embodiments of connections that can be made between the transmitting device 105 and the receiving device 110.

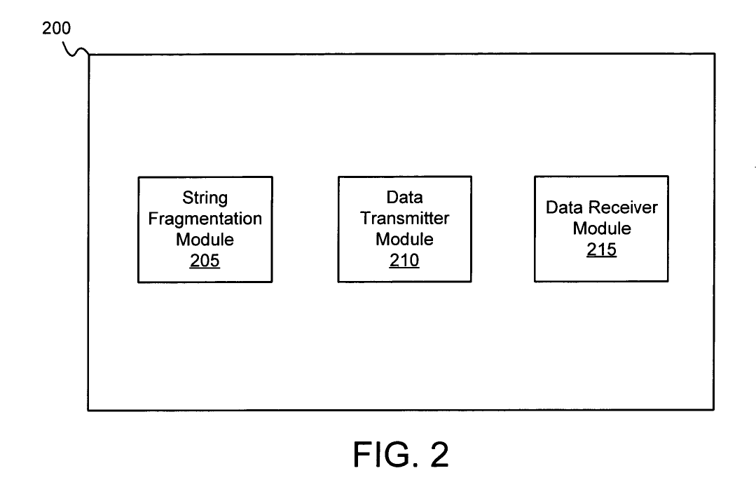

FIG. 2 depicts one embodiment of an apparatus for transporting data 200. The apparatus 200 is included as one component of both the transmitting device 105 and the receiving device 110 of FIG. 1. The apparatus 200 includes a string fragmentation module 205, a data transmitter module 210 and a data receiver module 215.

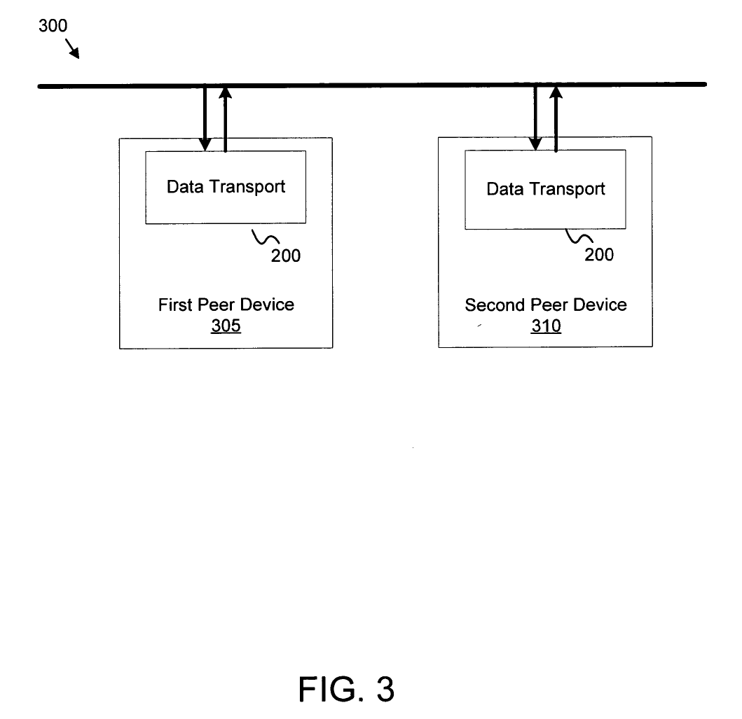

FIG. 3 depicts one embodiment of a system for data transport in a peer to peer configuration 300, in which the data transport apparatus 200 of FIG. 2 is included in each device on the network. In one embodiment, the first peer device 305 transmits the message to the second peer device 310. In an alternative embodiment, the second peer device 310 transmits the message to the first peer device 305. In a further embodiment, the first peer device 305 and the second peer device 310 are both transmitting and receiving messages simultaneously.

In one embodiment of the system 300 depicted, the connection between the first peer device 305 and the second peer device 310 is a single point to point connection. In an alternative embodiment, additional peer devices are added to the peer to peer network 300. In each of these embodiments, any physical connection may be made between the first peer device 305 and the second peer device 310 as set forth in FIG. 1.

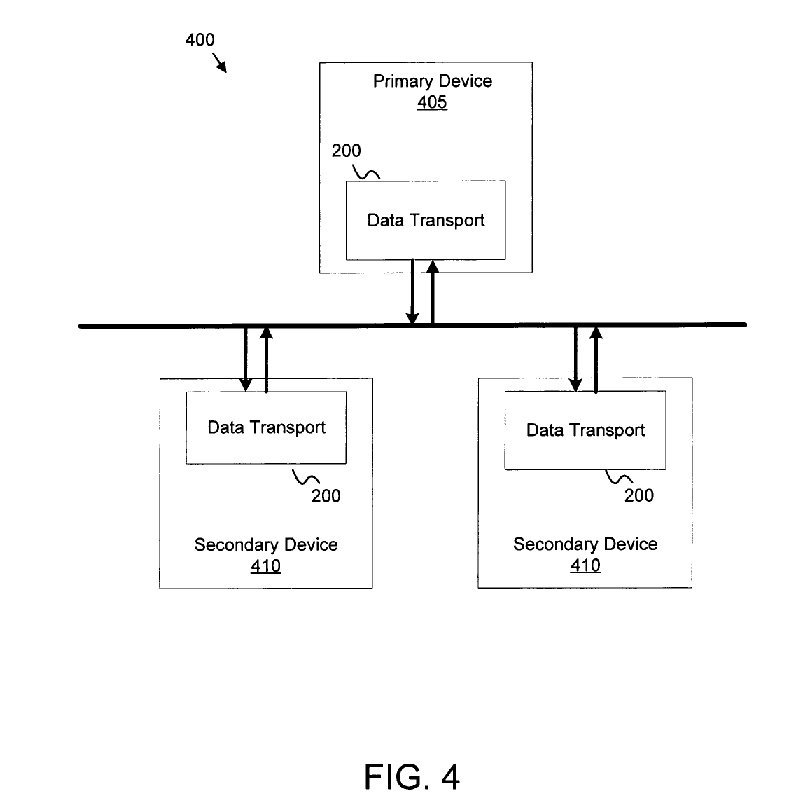

FIG. 4 depicts one embodiment of a system for data transport in a server-client network configuration 400 in which both, the primary device 405 and the secondary devices 410 are configured with the data transport module 200 of FIG. 2. In one embodiment, the primary device 405 transports data simultaneously to each secondary device 410. In an alternative embodiment, one of the secondary devices 410 may transport data independently with the primary device 405.

In one embodiment, the primary device 405 is a data server or application server. In an alternative embodiment the primary device 405 is a component of a network that is given priority as master device or controller of the network. Additionally, the secondary device 410 may be a work station, a data storage device, a slave device, or user of the network.

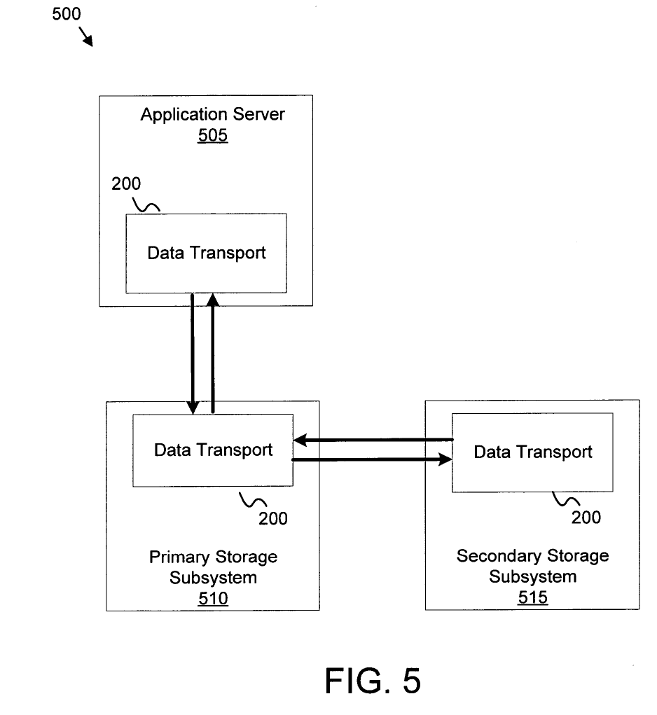

FIG. 5 depicts a system for data transport in an asynchronous peer to peer remote copy configuration 500. In this specific embodiment, an application server 505 transmits data to a primary storage subsystem 510. In one embodiment, the primary storage subsystem 510 replies to the application server 505 confirming successful handling of the message. In this embodiment, the message is then transmitted by the primary storage subsystem 510 to a secondary storage subsystem 515. The secondary storage subsystem 515 is preferably configured to reply to the primary storage subsystem confirming successful handling of the message. In one embodiment, the storage subsystem is an IBM TotalStorage™ Enterprise Storage Server Model 800.

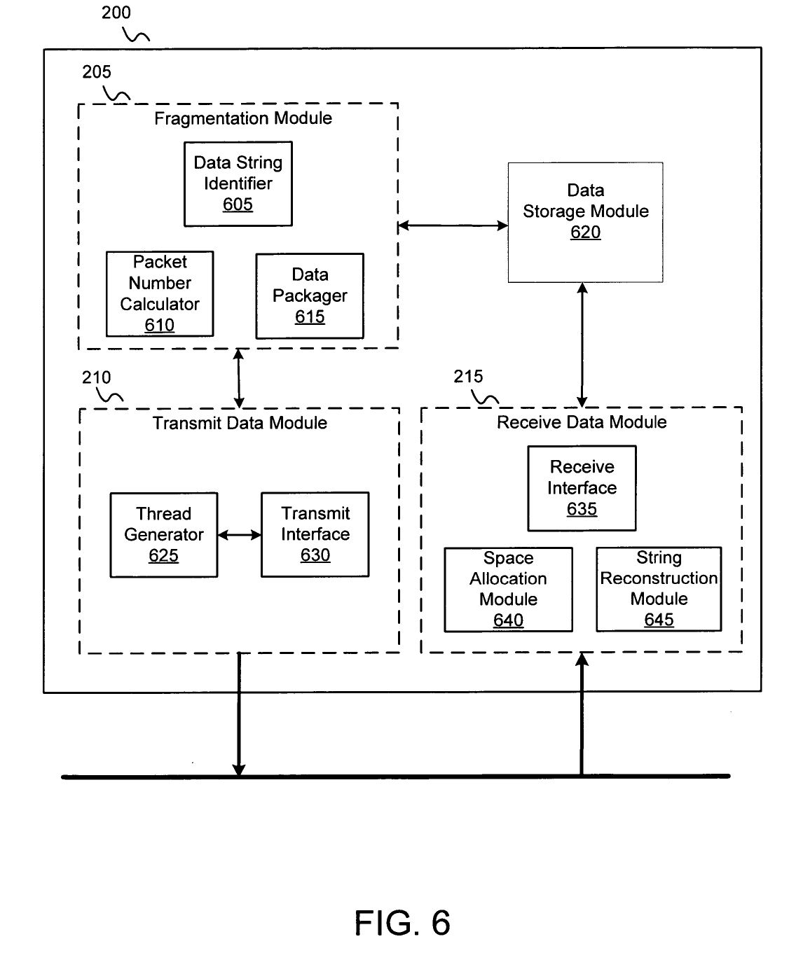

FIG. 6 depicts one detailed embodiment of the apparatus for data transport 200 of FIG. 2. The fragmentation module 205 includes a data string identifier module 605, a packet number calculator module 610, and a data packager module 615. The transmit data module 210 includes a thread generator module 625, and a transmit interface module 630. The receive data module 215 includes a receive interface module 635, a space allocation module 640 and a string reconstruction module 645. The fragmentation module 205 and the receive data module 215 interact with a data storage module 620. In one embodiment, the data storage module 620 is memory. In an alternative embodiment, the data storage module 620 is a buffer or cache device. In a further embodiment, the data storage module 620 is a storage disk.

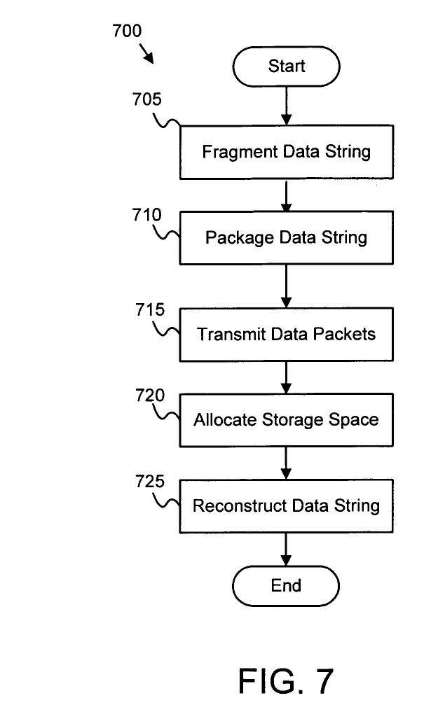

FIG. 7 depicts one embodiment of a method for transporting data 700. The method 700 includes fragmenting a data string into data packets 705, packaging the size of the data string with every data packet 710, transmitting the data packets 715 to a remote device, allocating storage space on a storage medium responsive to the length of the data string included with the first received data packet, and reconstructing the data string from the data packets on a remote device. In one embodiment the data string is a message to be sent from one device to the other. In an alternative embodiment, the data string is any combination of bits to be sent to a remote device. The method 700 may be carried out by computer readable code.

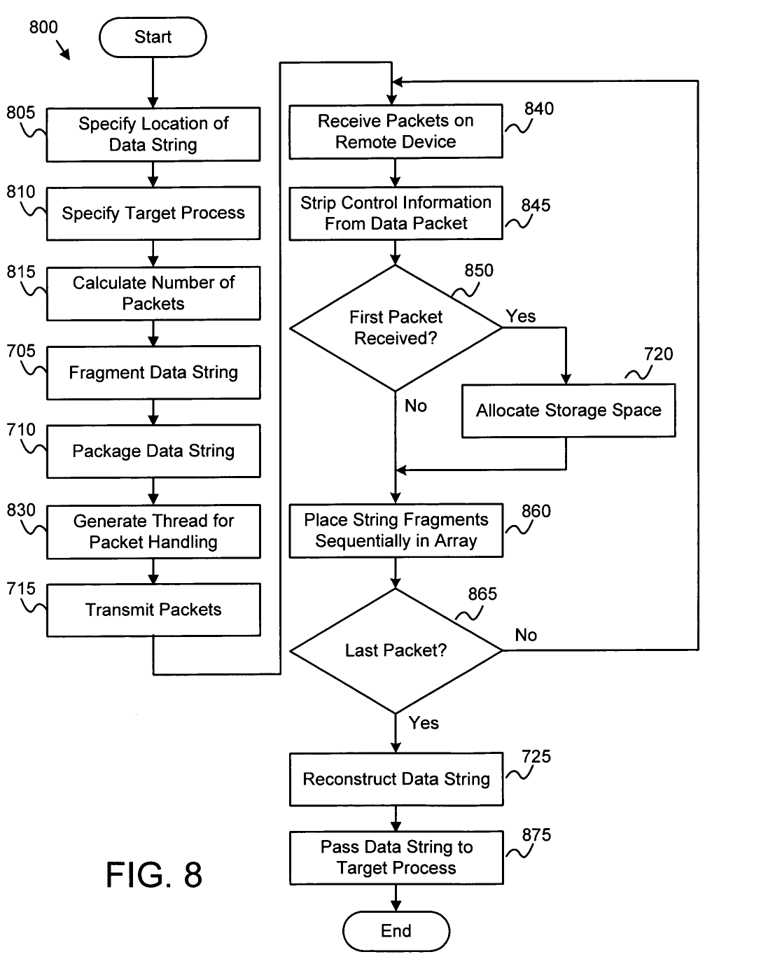

FIG. 8 depicts one detailed embodiment of a method for transporting data 800. In one embodiment, the method can be separated into steps to transmit the data string, and steps to reconstruct the data string. The data string identifier module 605 specifies the location of the data string to be transmitted 805 within the data storage module 620. In one embodiment, the data string identifier module 605 also specifies the target process 810 on a remote device. The packet number calculator module 610 calculates the number of packets required to completely transmit the data string 815. The data string is fragmented 705 into the number of fragments calculated in step 815. The string fragments are packaged 710, by the data packager module 615.

Each data packet is preferably configured to include control information including an identifier linking the data packet to the data string, the size of the data string, the sequence number of the data packet and the identifier indicating the last packet in the sequence. In a certain embodiment, a process thread is generated 830 by the thread generator module 625 to handle the transmission of the data packet. The packets are then transmitted 715 concurrently to a remote device via the transmit interface module 630.

In this embodiment, the remote device receives the data packets 840 via the receive interface module 635. The control information is then stripped 845 from the data packet. If the data packet is the first received 850 for a particular data string, space is accurately allocated 720 on a data storage module 620 by the space allocation module 640. The string fragment is then placed 860 sequentially in an array by index number. If the data packet is not the first received 850 for a particular data string, the fragment is placed 860 directly into the array in order by sequence number. In one embodiment, the string fragments are placed 850 in an array of arrays.

In an alternative embodiment, the string fragments are placed 850 in an array of linked lists. In an additional alternative embodiment, the array only contains pointers to the locations elsewhere in the data storage device 620, in which the string fragments have been place 850. Upon receipt 840 of the final packet 865, the data string is reconstructed 725 by the string reconstruction module 645. In one embodiment, the number of elements in the first array is determined by the level of activity within the receiver, or the number of outstanding data strings. In an alternative embodiment, the data string is compiled and stored as a whole entity. The data string is then passed to the target process 875 as specified 810 by the data string identifier module 605. The method 800 may be carried out by computer readable code.

Although for purposes of clarity the method 800 is depicted in a certain sequential order, execution may be conducted in parallel and not necessarily in the depicted order.

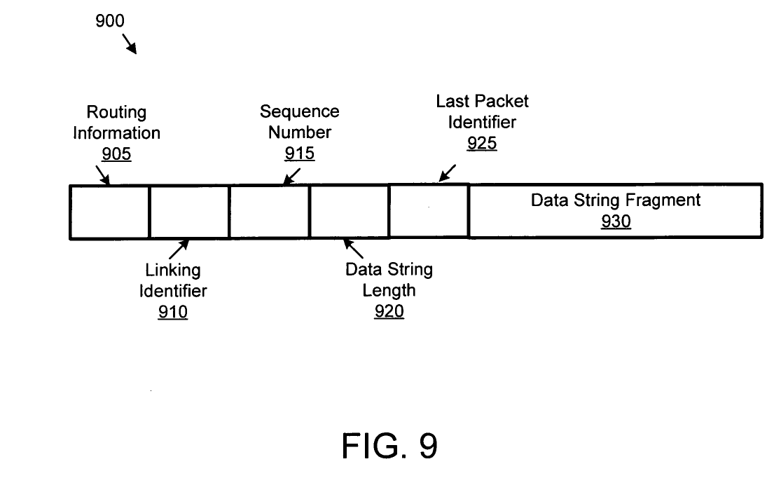

FIG. 9 depicts one embodiment of the data packet structure. The packet is segmented into control information including routing information 905 to enable the packet to be directed to the appropriate receiving device, the linking identifier 910 linking the data packet to the data string, the sequence number 915 of the data packet for placement in the array, the length of the data string 920 for accurate allocation 720 of storage space, and the last packet identifier 925 to indicate the last data packet in the sequence. The packet also includes the string fragment 930 to be transmitted to the receiving device.

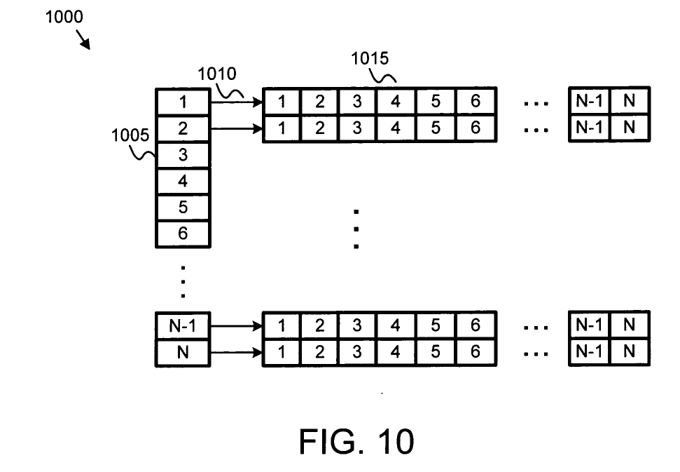

FIG. 10 depicts a graphical representation of an array of arrays 1000 for additional clarity. The structure of the array 1000 includes a first array 1005 comprising a variable number of elements. Each array element is linked 1010 to a second array 1015. In one embodiment, the link 1010 is a pointer the second array. The second array also containing a variable number of elements, the number being determined by the length of the data string. In one embodiment, the first array is dynamically allocated based on the number of outstanding data strings to be received. In one further embodiment, the string fragments are placed in the second array by index number, the index number being defined by the sequence number sent with the packet. The benefit of these embodiments is that storage space can be dynamically allocated to handle concurrent transport of multiple data strings, but the physical location of the second array elements containing the actual data strings does not have to change.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for transporting data, the apparatus comprising:
a string fragmentation module configured to fragment a data string into a plurality of data packets each configured with the length of the data string;
a data transmitter module configured to transmit the data packets; and
a data receiver module configured to receive the data packets from the data transmitter module, allocate space on a storage medium responsive to the length of the data string included with the first received data packet, and reconstruct the data string from data packets.

2. The apparatus of claim 1, wherein the string fragmentation module is further configured to package the string fragment with control information including an identifier linking the data packet to the original data string, the length of the original data string, the fragment sequence number, and an identifier indicating the last data packet in the sequence.

3. The apparatus of claim 2, wherein the string fragmentation module is further configured to specify a pointer to the location of the data string to be fragmented, and an identifier of the process on a remote device to receive the data string.

4. The apparatus of claim 2, wherein the string fragmentation module calculates the number of data packets required to completely transmit the data string.

5. The apparatus of claim 1, wherein the data transmitting module transmits the data packets to a remote device via a connection employing a data transfer protocol.

6. The apparatus of claim 5 wherein the data transmitting module is further configured to create threads to handle concurrent transmission of multiple data packets.

7. The apparatus of claim 1 wherein the data receiver module accurately allocates enough storage space to reconstruct the data string upon receipt of one of the packaged list fragments.

8. The apparatus of claim 7 wherein the data receiver module is further configured to insert the incoming list fragments sequentially into an array, the sequence being determined by the sequence number sent with the data packet, and reconstruct the data string upon receipt of all of the data packets.

9. An apparatus for receiving data, the apparatus comprising:
a data receiver module configured to receive the data packets from the data transmitter module, allocate space on a storage medium responsive to the length of the data string included with the first received data packet, and reconstruct the data string from data packets;
a data transmitter module on a remote device configured to transmit the data packets; and
a data fragmentation module on a remote device configured to fragment a data string into a plurality of packets each configured with the length of the data string.

10. A system for transporting data, the system comprising:
a transmitting device configured to fragment a data string into a plurality of data packets each configured with the length of the data string, and transmit the data packets to a remote device; and
a receiving device configured to receive the data packets from a transmitting device, allocate space on a storage medium responsive to the length of the data string included with the first received data packet, and reconstruct the data string from data packets.

11. The system of claim 10, wherein the transmitting device is further configured to package the string fragment with control information including an identifier linking the data packet to the original data string, the length of the original data string, the fragment sequence number, and an identifier indicating the last data packet in the sequence.

12. The system of claim 11, wherein the transmitting device is further configured to calculate the number of data packets required to completely transmit a data string; the data string being specified by a pointer to the location in a storage medium of the string.

13. The system of claim 11, wherein the transmitting device is further configured to create threads to handle concurrent transmission of multiple data packets, and transmits the data packet via a connection employing a data transfer protocol to a remote device.

14. The system of claim 10 wherein the receiving device accurately allocates enough storage space to reconstruct the data string upon receipt of one of the packaged list fragments, inserts the incoming list fragments sequentially into an array, the sequence being determined by the sequence number sent with the data packet, and reconstruct the data string upon receipt of all of the data packets.

15. A computer readable storage medium comprising computer readable code configured to carry out a method for transporting data, the method comprising:
fragmenting a data string into data packets;
packaging the size of the data string with every data packet;
transmitting the multiple data packets to a remote device;
allocating space on a storage medium responsive to the length of the data string included with the first received data packet; and
reconstructing the data string from the data packets on a remote device.

16. The computer readable storage medium of claim 15, wherein the method further comprises specifying a pointer to the location of the data string to be fragmented, and an identifier of the process on a remote device to receive the data string.

17. The computer readable storage medium of claim 15, wherein the method further comprises calculating the number of data packets required to completely transmit the data string.

18. The computer readable storage medium of claim 15, wherein the method further comprises packaging the string fragment with control information including an identifier linking the data packet to the original data string, the length of the original data string, the fragment sequence number, and an identifier indicating the last data packet in the sequence.

19. The computer readable storage medium of claim 15 wherein the method further comprises creating threads to handle concurrent transmission of multiple data packets.

20. The computer readable storage medium of claim 15 wherein upon receipt of one of the data packets, the remote device accurately allocates enough storage space to reconstruct the data string.

21. The computer readable storage medium of claim 20 wherein the method further comprises inserting the incoming list fragments sequentially into an array, the sequence being determined by the sequence number sent with the data packet, and reconstructing the data string upon receipt of all of the data packets.

22. A method for transporting data, the method comprising:
fragmenting a data string and packaging multiple data packets;
packaging the size of the data string with every data packet;
transmitting the multiple data packets to a remote device;
allocating space on a storage medium responsive to the length of the data string included with the first received data packet; and
reconstructing the data string from the data packets on a remote device.

23. The method of claim 22, wherein the method further comprises specifying a pointer to the location of the data string to be fragmented, and an identifier of the process on a remote device to receive the data string.

24. The method of claim 22, wherein the method further comprises calculating the number of data packets required to completely transmit the data string.

25. The method of claim 22, wherein the method further comprises packaging the string fragment with control information including an identifier linking the data packet to the original data string, the length of the original data string, the fragment sequence number, and an identifier indicating the last data packet in the sequence.

26. The method of claim 22, wherein the method further comprises transmitting the data packets to a remote device via a connection employing a data transfer protocol.

27. The method of claim 22, wherein the method further comprises creating threads to handle concurrent transmission of multiple data packets.

28. The method of claim 22, wherein upon receipt of one of the packaged list fragments, the remote device accurately allocates enough storage space to reconstruct the data string.

29. The method of claim 28, wherein the method further comprises inserting the incoming list fragments sequentially into an array, the sequence being determined by the sequence number sent with the data packet, and reconstructing the data string upon receipt of all of the data packets.

30. An apparatus for data transporting data, the apparatus comprising:
means for fragmenting a data string and packaging multiple data packets;
means for packaging the size of the data string with every data packet;
means for transmitting the multiple data packets to a remote device; and
means for reconstructing the data string from the data packets on a remote device.
